(19) United States
(12) Patent Application Publication
(10) Pub. No.: US 2017/0069220 A1
(43) Pub. Date: Mar. 9, 2017

(54) Method for Creating and Displaying Individualized Learning Material for Reading

(71) Applicant: Kenneth Thornton, Rockledge, FL (US)

(72) Inventor: Kenneth Thornton, Rockledge, FL (US)

(21) Appl. No.: 15/259,706

(22) Filed: Sep. 8, 2016

Related U.S. Application Data
(60) Provisional application No. 62/215,343, filed on Sep. 8, 2015.

(51) Int. Cl. G09B 17/00; G10L 13/08; G10L 15/26

(52) U.S. Cl. CPC G09B 17/006; G10L 15/26; G10L 13/08

(57) ABSTRACT

In one embodiment a method is provided by which a person learns to read text for which the person may already know the text vocabulary in the spoken language. A photographic image is generated which has an association with a spoken word for which the person is to learn to read a corresponding written word. The digital image is imported into a program running on a microprocessor based device. Associated text is entered into the computing device. At least one instructional flashcard is presented as custom reading material for learning to read text in association with the image.

### PRIORITY BASED ON RELATED APPLICATION

This application claims priority to U.S. Provisional Patent Application 62/215,343, filed 8 Sep. 2015.

### FIELD OF THE INVENTION

This invention relates generally to the field of reading materials and, more specifically, one embodiment concerns a system and a method for creating and displaying customizable reading material containing images and text of words audibly familiar to a person although the text may not initially be part of the person's reading vocabulary.

### SUMMARY OF THE INVENTION

A method is provided by which a person learns to read text associated with a language for which the person may already know the text vocabulary in the associated spoken language. The method includes generating one or more digitized photographic images each having an association with a spoken word for which the person is to learn to read a corresponding written word.

According to one series of embodiments, a program running on a microprocessor based device such as a smart phone, a tablet, a desk top computer or other computing device receives one or more digital images. Text associated with an object or activity associated with each image is entered into the program. Said image and associated text are merged into a digital flashcard. At least one flashcard is displayed for learning to read text associated with an image, where the flashcard comprises one of said one or more images and the associated text, and at least one flashcard is presented as custom reading materials on a display. The text may be created using voice recognition software. The displayed image may be a video. The method may include playing audio information that recites the text while an associated image is presented.

Embodiments of the invention provide methods that allow for the efficient capture and display of reading materials containing images and associated text that are specific to a person's spoken environment. A feature of these embodiments is the customizing of an automated presentation of reading materials to suit a particular vocabulary for a specific person.

Advantages and features of the present invention will become apparent from the following description when read in conjunction with the accompanying drawings which describe an example embodiment of the present invention.

One embodiment of the invention includes a program with which a method is performed with a microprocessor based device for customizing the program and operating the program to display individualized reading material containing images and text particular to a person's spoken vocabulary. When the device is a handheld such as a smart phone, a digitized image is generated with a camera, which may be integrated with the handheld device. Vocabulary text descriptive of the image is entered with, for example, a keyboard or a touch screen. The entered text may be immediately displayed with the image. Data for generation and display of instructional reading material comprising both image information and associated text, referred to as flashcards, are electronically stored in the device.

After creating customized flashcards, a method of using the flashcards includes selecting a stored image and associated text for simultaneous display as reading material specific to the person with a limited reading vocabulary. Optionally, the text may be presented as sequentially displayed individual or combined letters, and may be highlighted, boldfaced, enlarged, audio played or otherwise emphasized to facilitate phonetic reading.

### BRIEF DESCRIPTION OF THE DRAWINGS

Aspects and advantages of the present invention will be more clearly understood by those skilled in the art when the following description is read with reference to the accompanying drawings wherein:

FIG. 1 is a perspective view of a child's stuffed toy;

FIG. 2 is a perspective view of an image of the stuffed toy captured by the digital camera of a smart phone or a tablet;

FIG. 3 is a perspective view of an adult entering text which is the name a child assigns to the stuffed toy, which text is a word in the existing spoken vocabulary of that particular child;

FIG. 4 is a perspective view of a digital flashcard comprising the image shown in FIG. 2 and the text describing the stuffed toy displayed together as an adult reads the text to the child;

FIG. 5 is a flowchart describing a method of generating the flashcard of FIG. 4; and

FIG. 6 is a flowchart illustrating a method of using the flashcard.

Features of the described embodiments are not necessarily drawn to scale in the figures. The figures facilitate illustration of specific features relevant to the invention. Like reference characters denote like elements throughout the figures and text.

### DETAILED DESCRIPTION OF THE INVENTION

This application incorporates by reference the following U.S. Pat. Nos.: 7,422,434; 6,227,863; 6,004,135; 5,820,379; and 5,538,430.

An example of a person with a spoken vocabulary but limited reading vocabulary would be a young child. While methods according to the invention are suitable for use by older children, by children or adults with reading difficulties, and by adults desiring to develop a reading vocabulary in an additional language, the disclosed embodiment illustrates application of the invention to the case of a child at an initial stage of learning to read.

Prior art reading materials such as those disclosed in the patents incorporated by reference consist largely of books or similar printed matter. Where the prior art makes use of computer systems, the images and words presented are predetermined and typically not specific to the unique speaking vocabulary of a particular child. Prior learning methods have not utilized context dependent advantages to facilitate learning and overcome challenges of quickly developing a reading vocabulary as now addressed by the current invention.

Conventional books may be suitable for older children to advance their reading skills, especially when a child has a significant vocabulary of widely-used words, but this is not true for younger children (e.g., up to five years of age), where environmentally-specific words are often developed within the family environment. For instance, although typical reading materials for children frequently include generic words such as dog, cat, girl, boy, brother, sister, teddy bear and other names for stuffed toys, none of these words may be within the vocabularies of very young children. That is, children typically will only know pets, siblings and stuffed toys by names, and often the names used by the child are modified forms, which may be regarded as limited use “baby-talk” versions that will simply be discarded in a later stage of child development. A feature of the invention is recognition that the very use of such personalized vocabulary facilitates the learning-to-read process for the child. Similarly, older children and adults with a reading age younger than the chronological age will have a spoken vocabulary that provides the most effective leverage for learning to read. Moreover, for an older person already having a reading capability in the person's native language, but desiring to learn to read in another language, the use of informal and personalized names, as opposed to generic nouns, also facilitates the learning process.

In an example corresponding to the illustrated embodiment, a young child may be familiar with and know the name of a family dog, which may be of the Dalmatian breed. Not only might the infant not know that the dog is a Dalmatian, but the child may have no idea that the pet is a dog. In this instance, a picture in a book might be labeled “dog” or “Dalmatian” and the child, at best, might point and say the dog's name. Further, to illustrate the example, the dog in a typical reading primer may look nothing like the family pet. That is, the dog is probably going to be a different size, a different color, a different breed and have different markings. To the child, a Labrador named “dog” in the book may look nothing like the family pet named Rover, a Chihuahua the child calls “Ro-Ro”.

Even seemingly obvious nouns for people that are taken for granted (e.g., man, woman, sister, brother, girl, boy, etc.) may have little or no meaning for a young child because, with the possible exception of titles like “Mama” and “Dada”, nearly everyone and practically everything in the environment of the child has a non-descriptive name. In addition, many of the early words of a child are unique to the child's family and may be baby-talk words. The result is that, with the majority of the early vocabulary of a young child often consisting of words particular to that child's family and perhaps unique to that child, the use of generic terms, as found in conventional learning materials, may be an unrecognized impediment in the child's learning experience because the child has to first learn the unfamiliar word before learning to read it. Particular words, specific to an infant's personal experience, are not to be found in any book unless that book is customized to the family of the child. Although minimally-customized books for older children are made, it is unlikely that comprehensive-tailored printed reading materials could be produced speedily and economically, e.g., each time a baby names a new toy or learns a new adjective such as the color of a ball or the flavor of a chocolate ice cream cone.

Because of the unique environment-specific vocabulary of young children it has not previously been possible to easily generate reading material for individual children. Even after the advent of computers, development of reading-teaching materials has been largely on the basis of common language with little or no customizing for the individual's environmental context as now provided according to the processes and methods herein described.

Throughout this description of the invention some words are used interchangeably to help readability. For example, the word “text” includes but is not limited to, singular or multiple words, indicia, names, nouns and symbols intended to connote any text information that the operating adult uses to accompany an image or convey a meaning, regardless whether the text is an ordinary word found in a common dictionary or a word that attempts to phonetically describe the name the child assigns to the subject of an image shown to the child. The word “image” includes but is not limited to singular or multiple examples of photographs, pictures, sketches or icons or text intended to convey any digital image used in this process of creating and displaying reading materials. The meaning of the word “customized” includes but is not limited to individualized and personalized material, and may convey the combination of an image with particular text (e.g., a name, an adjective or an action verb) associated with the subject matter of the image, e.g., a name of a subject or an activity shown in the image, such as playing with a ball or running.

The phrase “limited reading vocabulary” as used herein refers to the limited words that a person knows and can read in the particular language which the person is learning to read, and excludes words the person knows but cannot initially read in the language being learned. Examples of words excluded from a limited reading vocabulary have been described for the more common instances in the context of the environment of a young child, but the invention, more generally, applies to other cases of limited reading vocabulary, including but not limited to: Dyslexia, remedial reading for late-developing children and illiterate adults, persons rehabilitating from trauma and medical intervention, and those learning to read in a foreign language.

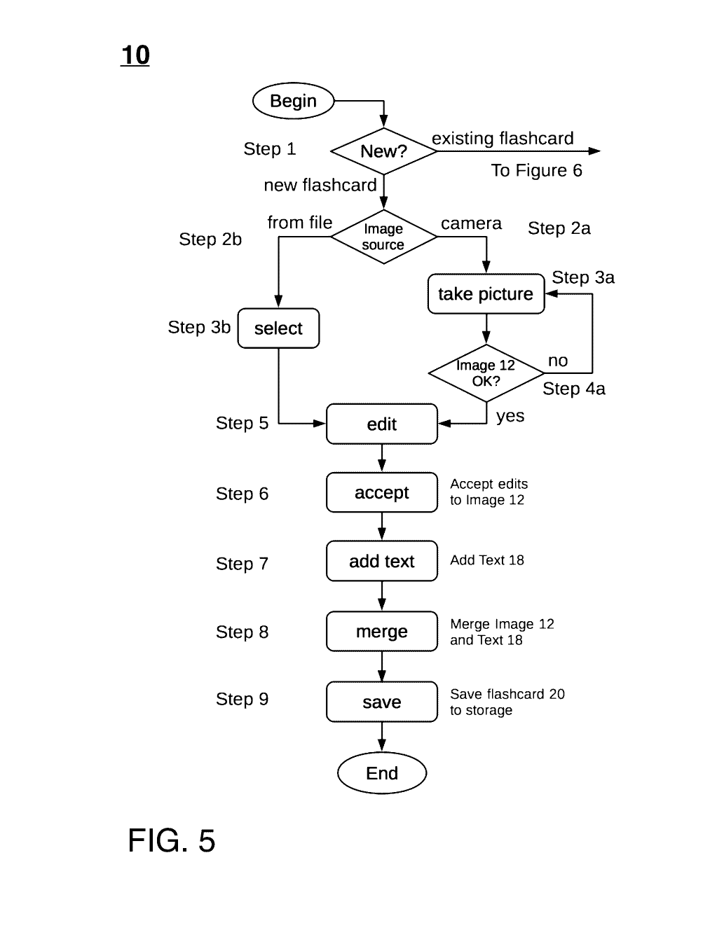

While the detailed description illustrates an exemplary embodiment of the invention, it is to be understood that the invention may be embodied in various other forms and the specific details disclosed herein are not limiting. With reference to the figures generally, a program 10 running on a computing device 16, e.g., a desk top or notebook computer, a smart phone, tablet or other portable computing device, leads the user through a sequence of steps such as illustrated in FIG. 5 to create reading materials 22 specific to the vocabulary of a particular person. The term computing device means any microprocessor-based device having memory, storage and a display. The exemplary method includes capturing one or more images 12 with a digital camera 14, e.g., a built-in camera or a camera external to the computing device 16. The program 10 enables the user to select, display and edit a particular image 12. When the image 12 is displayed, the program 10 prompts the user to type in text 18 related to a person or object in the image 12. The text 18 may be rendered in a manner that is more easily understood by the child such as with a phonetic interpretation of baby talk. The method stores this text 18 electronically in a manner that associates the text with the particular image 12 in a digital instructional flashcard 20. These steps may be repeated to create additional images 12, each with related text 18. Each combination of image 12 and related text 18 is stored electronically and made available to the program 10. Each combination of an image 12 and related text (20) is merged into a single instructional flashcard 20, said flashcard displayed in a manner that allows for presentation to the child. The aggregation of a plurality of instructional flashcards 20 form reading materials 22 customized to the specific vocabulary of the child.

Once the custom reading materials have been created, a user (e.g., an adult or other person facilitating the learning process) initially displays a single instructional flashcard 20, comprising an image and related text, to the child and reads the text to the child. Later, the child may use the material unattended. The user may read the text 18 to the child while pointing to the text 18 shown on the display of the computing device 16 in the same manner as using physical flashcards. The user may manually point, or use a cursor, to assist the child in associating letters and syllables with the spoken word.

The program 10 may also operate the computing device 16 to record audio so that the child's voice, or a voice familiar to the child, may read the text 18 by playing back the recorded audio. Thus the child's unique early vocabulary learning process can be implemented with individualized learning materials for reading development.

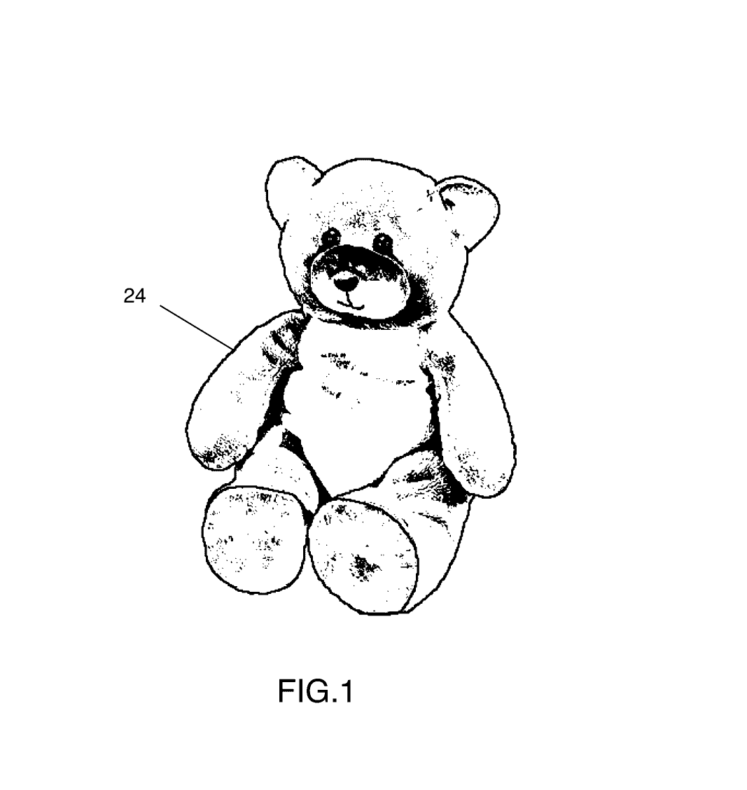

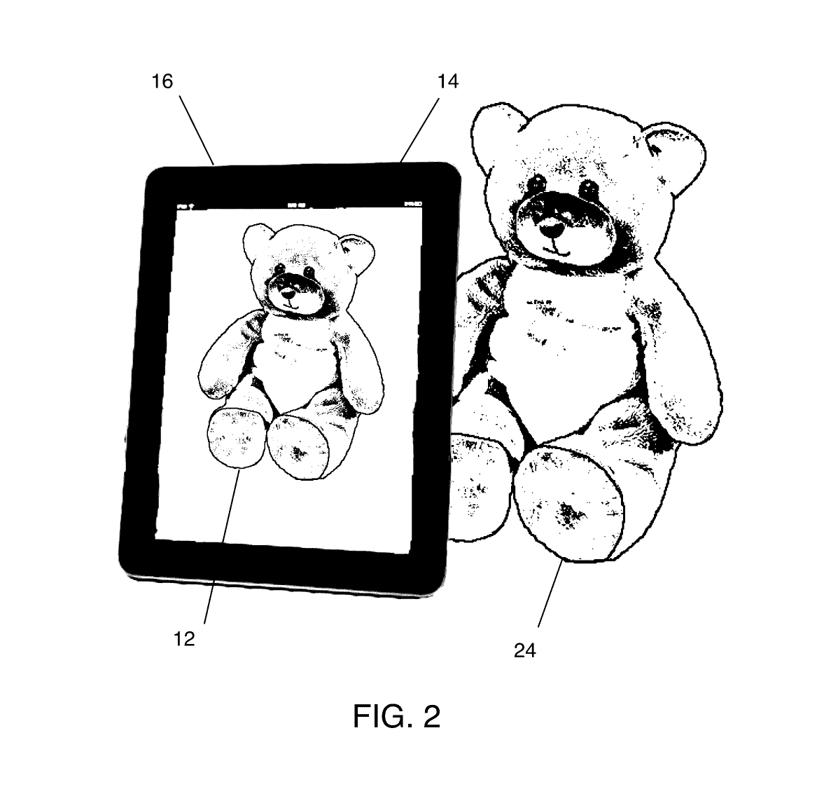

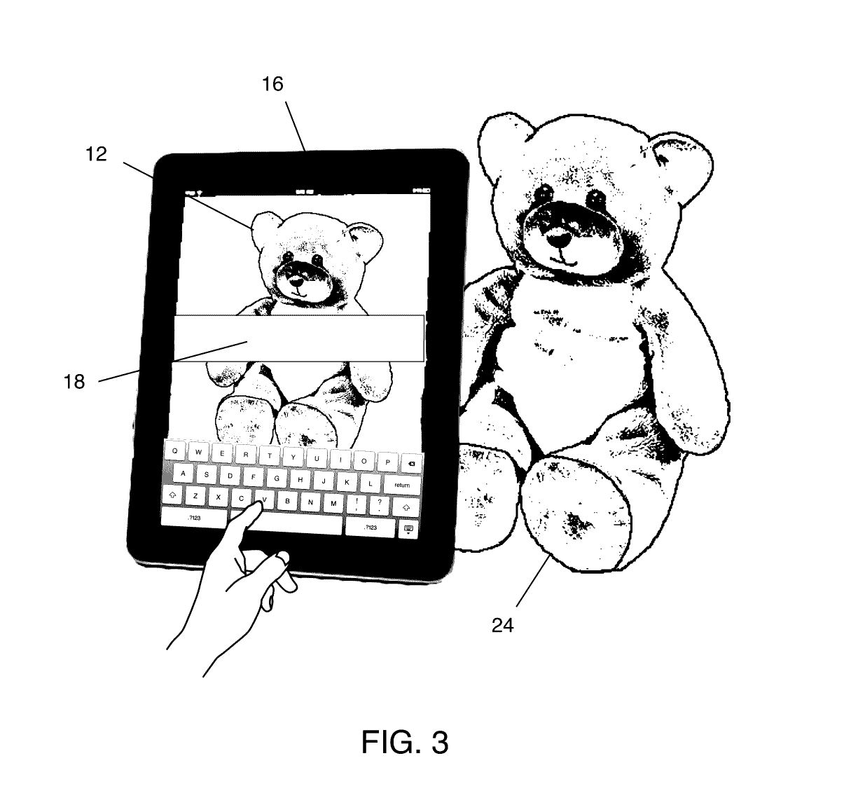

FIG. 1 shows a child's stuffed toy 24 of the type referred to as a “teddy bear”. FIG. 2 illustrates a tablet as the exemplary computing device 16, operated by a user taking a picture of the stuffed toy 24 of FIG. 1 using a built-in camera 14. FIG. 3 illustrates a user typing the text 18 on the tablet 16, said text related to the image 12 of the toy 24.

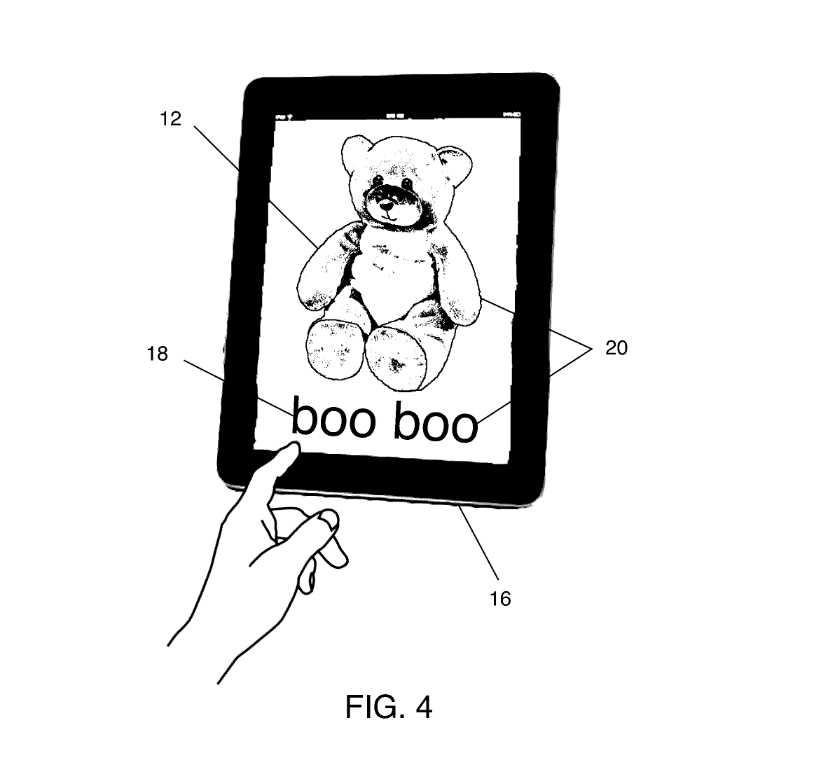

As shown in FIG. 4 the user presents to the child the digital flashcard 20 comprising the image 12 of the stuffed toy 24 and text 18 corresponding to the name the child assigns to the toy, displayed together, as the program 10 displays the image 12 and text 18 and the user reads the displayed text 18, e.g., as one word or sounded out as individual letters, to the child. This provides an individualized early learning experience in reading using words already familiar to the child.

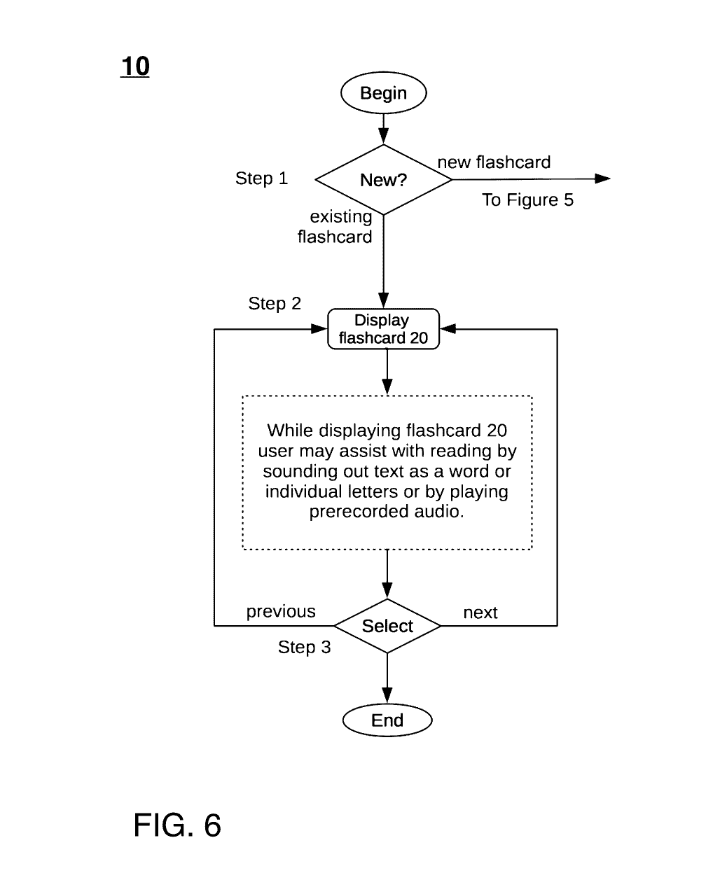

The program 10 comprises two modules shown in FIGS. 5 and 6 which illustrate exemplary steps to generate and display the reading material on a handheld device. Upon loading the program 10, in Step 1 the user selects whether to display an existing, previously stored flashcard 20, as described in FIG. 6, or to create a new flashcard, as described in FIG. 5, for display as described in FIG. 6.

Turning now to FIG. 5, with the Image Presentation Module of the Program 10, the user may select to create a new image 12 (Step 2a) by taking a picture using an on-board or attached camera which can be repeated until the user accepts a suitable picture (Step 3a and Step 4a). If the user chooses to use an existing image from file (Step 2b), a listing of folders containing images is displayed for the user to browse and make an image selection (Step 3b and Step 4b).

Once a digital image 12 is selected the user has the option in Step 5 of editing the image to center, align, crop, enlarge or otherwise edit the selected image. Once the edited version of the image 12 is accepted (Step 6) the user is prompted in Step 7 to input the learning text 20 and in Step 8 to create a merged flashcard 20 with the accepted photograph 12 and related text 18. On completion the flashcard 20 is saved automatically and the user is returned to Step 1.

FIG. 6 illustrates the Presentation Module of the Program 10 in simplified form where one or more flashcards 20 are sequentially displayed while the user assists a child with reading by sounding out words or individual letters of text 18. Reading by the user or the child can be recorded for the child's use. After selecting to display existing flashcards in Step 1 the first flashcard 20 in the selected folder is presented on the display in Step 2. During Step 2 the user may point to text and sound out the word or individual letters. After the child has seen and pronounced the text the user initiates program Step 4 by selecting from the options “previous” to display a previously displayed flashcard 20; or “next” to present a different flashcard 20 or “end” to end the Program (10 and cease the lesson.

While the invention has been described in connection with one embodiment, the scope of the invention is not so limited and the scope of the invention includes alternatives, modifications, and equivalents as may be readily apparent to one skilled in the art. For example, development of literacy in a second language has similarities to early childhood reading development in that the spoken word is typically known to the student before learning the written language. Further, the written form may be expressed with a different alphabet or symbol set. As one example, a person learning the Greek language may be familiar with the spoken word “hero”, but unaware that it is written as “Gyro”. This is particularly true when the target learning language is written in a non-familiar script such as Cyrillic or Arabic. The disclosed method of learning to read words that are already in a person's spoken vocabulary is also effective for learning to read a second language. In other embodiments, the instructional image may be provided as a video. In yet other embodiments, the text may be displayed in special

Page 8 fonts, colors and weights or other variations to assist with specific disabilities. The method, embodied as a program, may be made available on a non-transitory computer readable medium.

Accordingly, the scope of the invention is only limited by the claims which follow.

What is claimed is:

1. A method by which a person learns to read text associated with a language for which the person may already know the text vocabulary in the associated spoken language, comprising the steps of:
generating one or more digitized photographic images having an association with a spoken word for which the person is to learn to read a corresponding written word;
importing the one or more digital images to a program running on a microprocessor-based device;
entering text associated with an object or activity associated with each image;
displaying at least one instructional image flashcard comprising one of said one or more images and the associated text to present custom reading materials on a display for learning to read text in association with an image.

2. The method of claim 1 wherein the text is created using voice recognition software.

3. The method of claim 1 wherein the displayed image is a video.

4. The method of claim 1 further including playing audio information that recites the text while an associated image is presented.

5. The method of claim 1 wherein the letters of the text are individually displayed or emphasized or audio played with each letter or combination of letters to assist in phonetic learning.

6. The method of claim 1 wherein the letters of the text are displayed in various fonts, sizes, colors and weights or other variations to assist with disabilities.

7. The method of claim 1 wherein the method is applied to expand the reading ability of a person.

8. A non-transitory computer readable medium containing program instructions representing software executable in a microprocessor-based computing device comprising a processor, memory, storage and a display which instructions, when executed by the processor, cause the computing device to perform method steps for creating customized reading materials, the steps comprising:
receiving a digital image into the computing device;
receiving text input to the computing device by a user of the program instructions;
associating the digital image with the text in an instructional flashcard for presentation on the display; and
displaying at least one instructional flashcard to present custom reading materials on a display for learning to read the text in association with the image.

9. The non-transitory computer readable medium of claim 8 where the program instructions cause the computing device to perform a method step of aggregating a plurality of instructional flashcard to form customized reading materials.

10. The non-transitory computer readable medium of claim 8 where the program instructions cause the computing device to display at least one instructional image flashcard comprising one of said one or more images and the associated text to present custom reading materials on a display for learning to read text in association with an image.
